(19) United States
(12) Patent Application Publication
(10) Pub. No.: US 2014/0266574 A1
(43) Pub. Date: Sep. 18, 2014

(54) SYSTEM AND METHOD FOR MONITORING WATER LEVELS

(71) Applicant: Ovie V. Whitson, JR., Shady Shores, TX (US)

(72) Inventor: Ovie V. Whitson, JR., Shady Shores, TX (US)

(21) Appl. No.: 14/217,292

(22) Filed: Mar. 17, 2014

Related U.S. Application Data
(60) Provisional application No. 61/801,864, filed on Mar. 15, 2013.

(51) Int. Cl. G01F 23/00; G05B 11/01

(52) U.S. Cl. CPC G01F 23/0069; G05B 11/01
USPC 340/5.1

(57) ABSTRACT

The present invention provides a system for monitoring the water level of a swimming pool or other vessel. The system comprises a monitoring device and a base station. The monitoring device has a sensor for monitoring the water level, and a wireless transceiver for transmitting the water-level information to the base station. The monitoring device is located in the vessel approximate to the desired water level. In the case of a swimming pool, the monitoring device is preferably located in the pool's skimmer. The base station is connected to a valve control means that controls a valve on a fill line. The base station causes the valve to open when water (or fluid) level falls below a threshold and closes the valve when the water level is above a threshold. Thus, the water level may be controlled.

### CROSS-REFERENCE TO RELATED APPLICATIONS

This application claims the benefit of U.S. Provisional Application No. 61/801,864, which is hereby incorporated by reference in its entirety.

### TECHNICAL FIELD

The invention relates generally to monitor water levels.

### BACKGROUND

Various water storage vessels require that their water level be maintained. The term water as used herein generally means fluids. Such vessels include, for example, swimming pools, storage tanks, water troughs, and stock ponds. The water level in such vessels often decreases from use, evaporation, leaks, etc. This requires that the water level be checked frequently. When the level is low, more water must be manually added when necessary. But, owners frequently fail to check the water level and refill the vessel. This can lead to costly damage to the vessel and/or associated equipment or livestock. For example, swimming pool pumps frequently burn up when owners fail to maintain sufficient water levels. Or, livestock may perish when inadequate water is provided in their water troughs. Fish in stock ponds may also perish if in sufficient water is maintained.

As such, there is a need for a device for monitoring water levels. There is also a need for that device to be able to automatically cause the water levels to be maintained.

### SUMMARY

The present invention provides a system for monitoring the water level of a swimming pool or other vessel. The system comprises a monitoring device and a base station. The monitoring device has a sensor for monitoring the water level, and a wireless transceiver for transmitting the water-level information to the base station. The monitoring device is located in the vessel approximate to the desired water level. In the case of a swimming pool, the monitoring device is preferably located in the pool's skimmer. The base station is connected to a valve control means that controls a valve on a fill line. The base station causes the valve to open when water (or fluid) level falls below a threshold and closes the valve when the water level is above a threshold. Thus, the water level may be controlled.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a diagram of a preferred system in accordance with the present invention exemplified in a typical residential swimming pool;

FIG. 2 is a block diagram of a monitoring device and a base station used in the preferred system; and

FIG. 3 is a block diagram of an alternate embodiment of a monitoring device in accordance with the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein. Additionally, as used herein, the term “substantially” is to be construed as a term of approximation.

It is noted that, unless indicated otherwise, all functions described herein may be performed by a processor such as a microprocessor, a controller, a microcontroller, an application-specific integrated circuit (ASIC), an electronic data processor, a computer, or the like, in accordance with code, such as program code, software, integrated circuits, and/or the like that are coded to perform such functions. Furthermore, it is considered that the design, development, and implementation details of all such code would be apparent to a person having ordinary skill in the art based upon a review of the present description of the invention.

Referring to FIG. 1, a preferred system 100 for monitoring water levels in a vessel 110 is provided. Here, system 100 is exemplified being installed in a residential swimming pool. The system 100 comprises monitoring device 200, which is located in or adjacent to vessel 110 approximate to the desired water level. In the case of a swimming pool, the monitoring device is preferably installed in the pool's skimmer 140. Fill line 130 is connected to the vessel and provides water to refill vessel 110. Fill line 130 has valve 370. Base station 300 is preferably installed near valve 370. Base station 300 is in wireless communication with monitoring device 200. When monitoring device 200 informs base station 300 that the water level in vessel 110 is below a threshold, the base station causes valve 370 to open, which causes more water to be added to the vessel from fill line 130. Monitoring device 200 detects when the water level has reached the desired level and communicates that to base station 300, which then causes valve 370 to close, thereby shutting-off fill line 130.

Referring to FIG. 2, preferred embodiments of monitoring device 200 and base station 300 are provided. Monitoring device 200 comprises a microprocessor 210, memory 220, a transceiver 230, a power supply 240, and a sensor 250. Sensor 250 detects the water level in a vessel in which it is installed. Preferably, sensor 250 is a capacitive sensor having a first trace submersed below the water and a second trace above (or at) the desired the water level. The capacitive sensor detects a change in capacitance when the water or fluid level falls below the traces. In alternate embodiments, sensor 250 may be a moisture sensor that detects moisture content instead of a water level. The moisture sensor is preferably a capacitive sensor similar to the water level sensor described above. Transceiver 230 permits two-way communication with base station 300, which allows it to report the water level of the vessel being monitored and any failures or errors to base station 300. Preferably, transceiver 230 uses a 900 MHz radio. Preferably, transceiver 230 may also be powered off to conserve power. Microprocessor 210 may power up the transceiver periodically and make a quick connection to the base station to receive and transmit any necessary data, and then may power off the transceiver to conserve power. Power supply 240 may be a battery. As such, no wiring is needed to and from monitoring device 200.

Base station 300 comprises a microprocessor 310, memory 320, a transceiver 330, a power supply 340, and a user interface 350. Transceiver 330 permits wireless communication with one or more monitoring devices 200. The transceiver may send instruction to monitoring device 200, e.g., to set times for reporting water levels or to adjust various parameters. Power supply 340 may be a battery, an energy harvesting power supply, or other means, including a wired connection. User interface 350 provides a means for programming the system. The user interface may be a keypad, touchscreen, wireless interface (e.g., 802.11), Ethernet connection, cellular connection, or a USB connection. Preferably, the user interface provides a connection to the Internet, which allows a user to connect via a PC or smart phone to program the system and also receive updates and alerts. Memory 320 is used to store user instruction and water-level information received. Base station 300 is connected to a valve control means 360, which turns on or off valve 370, which controls a fill line. Valve control means 360 is preferably an solenoid.

Referring to FIG. 3, an alternate embodiment is provided. Monitoring device 400 comprises a microprocessor 410, memory 420, a transceiver 430, a power supply 440, and a sensor 450. Sensor 450 detects the water or fluid level of a vessel in which it is installed. Preferably, sensor 450 has a first trace submersed in the water or fluid and one trace above (or at) the desired the water or fluid level. The sensor detects a change in capacitance when the water or fluid level falls below the traces. In alternate embodiments, sensor 450 may be a moisture sensor. Transceiver 430 is a cellular transceiver or a Wi-Fi transceiver. Transceiver 430 permits a connection to the Internet, which allows it to alert the owner via email, text message, push message, automated call, etc., that the water level is low, thus allowing the owner to take corrective action. Preferably, transceiver 430 may also be powered off to conserve power. Microprocessor 410 may power up the transceiver periodically if needed to report a change in the water level, and then may power off the transceiver to conserve power. Power supply 440 may be a battery. As such, no wiring is needed to and from monitoring device 400. This embodiment is particularly well suited for use where automated means for re-filling are not available or are impractical, such as re-filling a large stock pond. In such a case, the owner may take other remedial actions upon being alerted.

In embodiments where the sensor (250 or 450) is a moisture sensor, the monitoring device (200 or 400) may be used to monitor the moisture content within the vessel. For example, the monitoring device may be placed in livestock feeders to measure the moisture content of feed, thus allowing ranchers to know if the feed is spoiled. Another use is with windmill applications. Most windmills pump water into a storage tank or water trough, and ranchers or pet owners have to check these levels in person. The present invention allows for the information to be displayed in an email, text message, or a webpage, thus eliminating the need for the owner to check the levels in person.

It is understood that the present invention may take many forms and embodiments. Accordingly, several variations may be made in the foregoing without departing from the spirit or the scope of the invention.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered obvious and desirable by those skilled in the art based upon a review of the foregoing description of preferred embodiments. Accordingly, it is appropriate that the appended claims be construed broadly and in a manner consistent with the scope of the invention.

1. An apparatus comprising:
a sensor configured for detecting the water level in a vessel and generating a first signal when the sensor detects that the water level in the vessel is below a predetermined level;
a microprocessor connected to the sensor;
a wireless transmitter connected to the microprocessor;
wherein the microprocessor is configured to generate a second signal to the wireless transmitter in response to receiving the first signal from the sensor; and
wherein the transmitter is configured to transmit a third signal when the second signal is received from the microprocessor.

2. The apparatus of claim 1 wherein the vessel is a swimming pool.

3. The apparatus of claim 1 wherein the vessel is a storage tank.

4. The apparatus of claim 1 wherein the vessel is a water trough.

5. The apparatus of claim 1 wherein the vessel is a stock pond.

6. The apparatus of claim 1 wherein the transmitter is a transceiver.

7. The apparatus of claim 1 wherein the transmitter is a cellular transceiver.

8. The apparatus of claim 1 wherein the transmitter is a wireless local area network (WLAN) transceiver.

9. The apparatus of claim 1 wherein the sensor is a capacitive-sense sensor.

10. An apparatus comprising:
a sensor configured for detecting the moisture level in a vessel and generating a first signal when the sensor detects that the moisture level in the vessel is below a predetermined level;
a microprocessor connected to the sensor;
a wireless transmitter connected to the microprocessor;
wherein the microprocessor is configured to generate a second signal to the wireless transmitter in response to receiving the first signal from the sensor; and
wherein the transmitter is configured to transmit a third signal when the second signal is received from the microprocessor.

11. A base station to monitoring the water level in a vessel, the base station comprising:
a wireless receiver configured for receiving a first wireless signal from a monitoring device that indicates that the water level in the vessel is below a predetermined level and generating a second signal in response to receiving the first signal; and
a microprocessor connected to the receiver,
wherein the microprocessor is configured to receive the second signal and generate a third signal in response to receiving the second signal that causes a valve on a fill line to open.

12. A system for monitoring the water level in a vessel, the system comprising:
a monitoring device having a water-level sensor for detecting the water level in the vessel, the monitoring device configured to generate a first signal to a base station when the sensor detects that the water level is below a predetermined level; and
the base station being configured to generate a second signal that causes a valve on a fill line to open in response to receiving the first signal.

13. The system of claim 12, wherein:
the monitoring device is configured to generate a third signal to a base station when the sensor detects that the water level is at or above a predetermined level; and
the base station being configured to generate a fourth signal that causes the valve on the fill line to close in response to receiving the third signal.

14. A method for monitoring the water levels in a vessel, the method comprising the steps of:
detecting that the water level in the vessel is below a predetermined level;
generating a first wireless signal when the water level detected to be below a predetermined level;
generating a second signal in response to receiving the first signal; and
causing a valve on a fill line to open upon receiving the second signal, thereby refilling of the vessel.

15. The method of claim 14 further comprising the steps of:
detecting that the water level in the vessel is at or above a predetermined level;
generating a third wireless signal when the water level detected to be at or above a predetermined level;
generating a fourth signal in response to receiving the third signal; and
causing a valve on a fill line to close upon receiving the fourth signal, thereby stopping the refilling of the vessel.
